(19) United States
(12) Patent Application Publication
(10) Pub. No.: US 2022/0292999 A1
(43) Pub. Date: Sep. 15, 2022

(54) REAL TIME TRAINING

(71) Applicants: AT&T Intellectual Property I, L.P., Atlanta, GA (US); AT&T Mobility II LLC, Atlanta, GA (US)

(72) Inventors: Matthew Kratzer, Fort Mitchell, KY (US); Gary Gadson, Frisco, TX (US); Justin Hone, Boise, ID (US); Sean Griffith, Castle Rock, CO (US); Christopher Rebacz, Centennial, CO (US); Jonathan Remington, Coppell, TX (US); Antoine Diffloth, Frisco, TX (US); Arvind Shankar Prabhakar, San Mateo, CA (US); Qiuying Jiang, Sunnyvale, CA (US); Michael Lemen, Dallas, TX (US); Michael Maher, Eureka, MO (US); Aaron Thomas, Dallas, TX (US); David E. Patterson, Los Altos, CA (US)

(73) Assignees: AT&T Intellectual Property I, L.P., Atlanta, GA (US); AT&T Mobility II LLC, Atlanta, GA (US)

(21) Appl. No.: 17/201,672

(22) Filed: Mar. 15, 2021

(51) Int. Cl. G09B 7/04; G06Q 10/06; G06N 20/00; G06Q 50/20

(52) U.S. Cl. CPC G09B 7/04; G06Q 10/06393; G06N 20/00; G06Q 50/20

(57) ABSTRACT

Aspects of the subject disclosure may include, for example, receiving employee performance data for a group of employees including a particular employee, the employee performance data including particular performance data for the particular employee, the employee performance data associated with key performance indicator (KPIs) for the group of employees including a particular KPI associated with the a task performed by the particular employee; determining, for a plurality of training courses, a probability of each training course being associated with improved performance by the group of employees for each KPI of the KPIs; producing a probability distribution and a confidence score, recommending, based on the probability distribution, one or more recommended training courses for the employee; exploring, based on the confidence score, training courses of the plurality of training courses having a relatively low confidence score; receiving subsequent performance data for a time period following completion of the one or more recommended training courses by the particular employee; evaluating effectiveness of the one or more training courses based on the subsequent performance data; and modifying at least one recommended training course of the one or more recommended training courses, wherein the modifying is responsive to the evaluating effectiveness. Other embodiments are disclosed.

### FIELD OF THE DISCLOSURE

The subject disclosure relates to a system and method for training of individuals including employees in a workplace.

### BACKGROUND

Training of employees and others has been developed largely to train only large, homogeneous audiences without attention to individual needs or differences. Further, the success of training has been difficult to measure.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a flow diagram illustrating an overall workflow for a real time training system and method in accordance with various aspects described herein.

FIG. 2C depicts an illustrative embodiment of a recommendation engine for a real time training system and method in accordance with various aspects described herein.

FIG. 2D depicts an illustrative embodiment of a basic workflow of a multi-armed bandit (MAB) model for a real time training program in accordance with various aspects described herein.

FIG. 2E depicts an illustrative embodiment of a data flow of a MAB model for a real time training program in accordance with various aspects described herein.

FIG. 2F depicts an illustrative embodiment of data for measuring effects of a training course and for detecting a performance change for a MAB model for a real time training program in accordance with various aspects described herein.

FIG. 2G shows a conceptual diagram for measuring effect of training courses using naive Bayes modeling with bootstrapping in accordance with various aspects described herein.

FIG. 2H is a plot of calculated course effectiveness in accordance with various aspects described herein.

FIG. 2I is a plot of outcome of Thompson Sampling for a MAB model in accordance with various aspects described herein.

FIG. 2J is a flow diagram illustrating an enhancement to a MAB model.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for individualizing training for an individual, such as for an employee, based in part on past performance of the individual, to target the training at the individual level. Conventionally, training in the industrial context is not at the individual level and is not performance driven. In accordance with aspects disclosed herein, data can be collected to make the training individualized and based on an individual's performance and can be delivered to the learner when needed. The system and method detect when training is needed by an individual, determine what training is needed by that individual and delivers it to that individual at the time it is needed by the individual. Moreover, rather than delivering an entire course of material to the individual, the system and method deliver information about just one subject or topic within a course. Thus, a training unit may be at most 15 minutes in duration and very focused on the individual's current needs for performance improvement for a specific task. This is an improvement over the conventional manner of sending a large group of trainees for group learning of an entire course, at a time when a group class is scheduled or available and independent of individual needs. Machine learning and other algorithms may be used in accordance with some embodiments to automate operation to take into account many variables for individualized training including training they have already had to eliminate duplication. Since time is valuable for employees and other learners and they must be taken away from their jobs or other tasks for training, the system and method maximize the effectiveness of the training while minimizing disruption to other work tasks.

The system and method in accordance with various embodiments may be applied to a wide range of training scenarios. In some cases, data may show that a sales agent is not selling enough of a particular product. The sales agent can be given additional, focused training on that aspect of the job. In other cases, data may show an increase of repeat service calls because an agent who handles the service calls needs additional training. The system and method may have particular application to learners for whom a lot of performance data is available. In many cases, such learners are front-line employees, like retail sales clerks or service agents. In other cases, such learners may work in a warehouse moving products into, around and out of the warehouse as orders from customers are being filled. Such warehouse employees may generate data about the number of items moved, the amount of time required and other data as well. Automated systems can collect data about performance of such employees that may be used to quantify the employee's performance, identify appropriate training and then evaluate the effectiveness of the training. Other embodiments are described in the subject disclosure.

One or more aspects of the subject disclosure include receiving learning content information about one or more training courses, wherein each course of the one or more training courses is targeted to a specific key performance indicator of an organization, receiving metric information about employee key performance indicators (KPIs) for performance of an employee, and generating, by a machine learning model, a training recommendation for the employee, wherein the generating comprises matching the metric information about employee KPIs to the learning content information of the one or more training courses. One or more further aspects include producing a list of recommended courses for the employee based on the training recommendation, receiving information about completion of a training course of the recommended courses for the employee, collecting performance information about the employee KPIs for the performance of the employee following the completion of the training course, comparing the performance information about the employee KPIs with the metric information about employee KPIs to produce a performance comparison, and modifying content of the training course based on the performance comparison.

One or more aspects of the subject disclosure include receiving employee performance data for a group of employees including a particular employee, the employee performance data including particular performance data for the particular employee, the employee performance data associated with key performance indicator (KPIs) for the group of employees including a particular KPI associated with the a task performed by the particular employee; determining, for a plurality of training courses, a probability of each training course being associated with improved performance by the group of employees for each KPI of the KPIs; producing a probability distribution and a confidence score, recommending, based on the probability distribution, one or more recommended training courses for the employee; exploring, based on the confidence score, training courses of the plurality of training courses having a relatively low confidence score; receiving subsequent performance data for a time period following completion of the one or more recommended training courses by the particular employee; evaluating effectiveness of the one or more training courses based on the subsequent performance data; and modifying at least one recommended training course of the one or more recommended training courses, wherein the modifying is responsive to the evaluating effectiveness.

One or more aspects of the subject disclosure include receiving key performance indicator (KPI) performance data for an employee, wherein the KPI performance data is related to a particular job function of the employee in a role of the employee for a just completed time period, and recommending a training course for the employee, wherein the recommending is based on the KPI performance data, a tenure of the employee in the role and a confidence level for the training course, the training course to be completed by the employee in an immediately following time period. One or more further aspects include determining that the employee has completed the training course, receiving subsequent KPI performance data for the employee after the employee has completed the training, and updating the confidence level for the training course based on the subsequent KPI performance data.

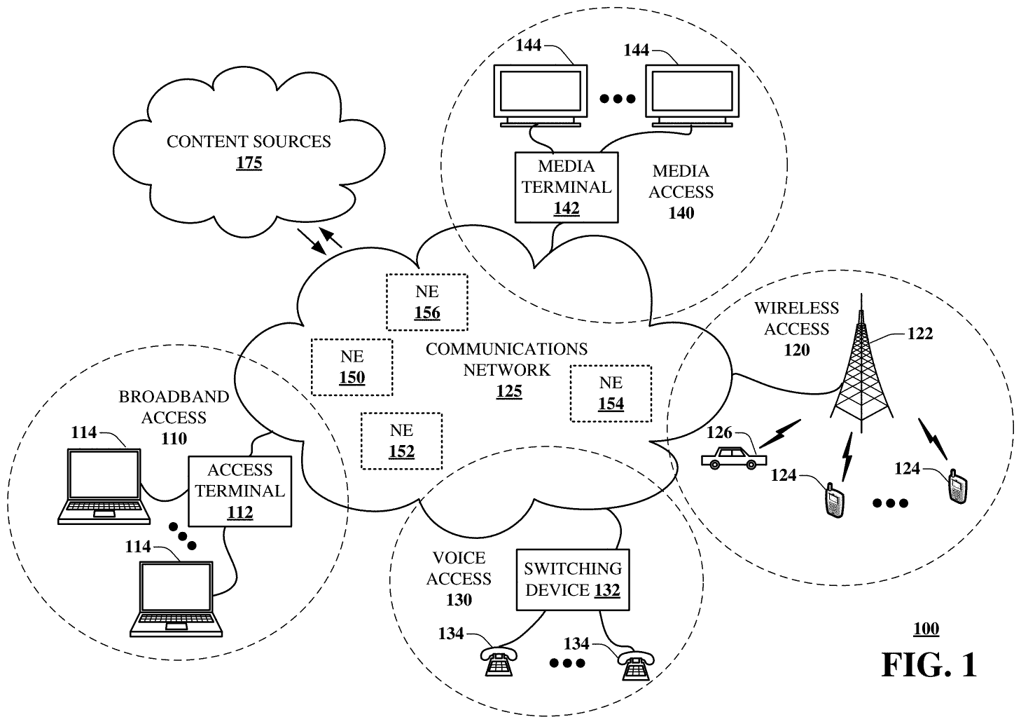

Referring now to FIG. 1, a block diagram is shown illustrating an example, non-limiting embodiment of a system 100 in accordance with various aspects described herein. For example, system 100 can facilitate in whole or in part implementing a real time training system for learners including employees of an organization in which training courses are recommended based on performance data for the learners using a machine learning model. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In accordance with some embodiments described herein, micro-learning courses that are shown to improve specific Key Performance Indicators (KPIs) defined and monitored by an organization are automatically sent and recommended to individual employees or other learners that are failing to meet desired outcomes within those performance indicators. Data is analyzed to identify which courses are impacting performance the most. Confidence scores for the most impactful courses increase and as a result are recommended more often. In addition, this analysis will lead to identification of the design elements within individual micro-learning courses that have the greatest and least impact on performance improvement and thus improve design. Other analytics include individual learner interactions within a micro-learning course, i.e. how long does a learner spend on a particular element and are there correlations to training quiz scores or post-training performance impact based on any of these interaction trends. Machine learning models are created to be flexible and used across similar and different business units. Embodiments provide the ability to dynamically assemble the most effective micro-learning courses into more robust training paths that can be leveraged beyond performance improvement to more effectively onboard new employees and upskill existing employees that need to gain new knowledge. Embodiments incorporate behavioral data into data modeling in addition to KPIs and other data sources available today. Examples of behavioral data may include on the job observation results and scoring components from quality assurance reviews. Where applicable, key performance indicators are weighted based on the business unit's current objectives. Subsequently, the specific courses and frequency at which they are recommended to employees is based on these weightings. This results in a system proportionately focusing its efforts in areas that contribute the most to employee and business unit success.

Embodiments may deliver training recommendations automatically to the end-user within the systems the end-user uses every day. This may prevent the end-user from having to search through large libraries of content manually. Embodiments automate the analysis and delivery of micro-learning based on sales and service performance to goal at the individual employee level. This reduces the amount of human intervention needed for operational analysis and extends more time to leaders to coach on performance and reinforce training. This also increases the accuracy of the performance analysis.

Embodiments leverage small, targeted training elements to increase knowledge retention and deliver the most relevant knowledge just in time to the individual learner. This leads to quicker application of knowledge gained through training and accelerates performance improvement. The concept of a micro-learning course is used. Such a course is very short in duration, such as only 15 minutes long. Such a course is tightly focused on a particular performance indicator that can be measured and quantified and is a part of a larger set of tasks of the employee. Examples include particular questions asked of a customer by a call center employee or a particular number of packages delivered by a warehouse employee. Such small micro-learning courses can then be used to create larger end-to-end courses and vice versa.

In order to infer the effectiveness of and recommend courses, embodiments use Contextual Multi-Armed Bandits (cMAB or MAB) machine learning models. Such MAB models are a sub-field of Reinforcement Learning (RL). The MAB model is used to generate training recommendations for users. RL is an area of machine learning in which the agent decides on a set of actions that are taken in an environment in order to maximize some notion of reward; future actions are decided based on the results of the actions taken in the past, using a feedback loop. In the current scenario, the rewards are tied to improvements in KPI metrics and the actions are the courses which are suggested and then may be taken by the target audience. Use of MAB models also ensures that these actions are designed to be a function of a context, which in this case is a set of properties of the course and user, making the courses personalized. In order to address the lack of data in a training and reward history which comes with small sample sizes and the introduction of new courses, embodiments use MAB to balance two competing objectives, recommending courses to users in order to either (a) explore, i.e. generate data for courses whose impact is not fully understood, and (b) exploit, i.e. recommend courses which should increase KPI attainment.

One of the outputs of the MAB algorithm is a distribution of inferred effectiveness for each course given a context. Embodiments generate recommendations based on these distributions using Thompson Sampling or other similar algorithms. Each month, these recommendations are shown to users, and data on their impact, such as training completion and KPI metric changes, are used to automatically update the models for the next cycle.

To better distinguish the various training objects that are available for data recommendations, embodiments capture various metadata about the training itself. While the data captured does contain basic information about the training itself, such as duration and delivery mode, some embodiments also use multiple taxonomies to capture the many facets of the training content itself. These taxonomies are reusable across business types, but they are built to be flexible enough to focus on a specific business unit. These taxonomies can be used for initial recommendations on newer training that has not yet generated enough data to make a determination on effectiveness yet, to ensure some degree of relevance. At the same time, as the training data increases, this metadata also provides more information or insight into the type of training content that is driving impact. And when coupled with the target audience's learning history, this metadata can also help increase the confidence rating of a particular recommendation for a given learner.

Some embodiments make use of centralized performance and a behavioral data lake, referred to as CE Data. CE Data pulls in performance metrics data directly into the learning management system allowing the machine learning model access to performance towards assigned business goals for each individual employee or learner. The machine learning model is then able to analyze performance from the previous month, for example, as well as historical trending towards business goals, so that the ML model can make relevant recommendations that are more likely to improve performance. This also allows the ML model to review and compare the pre-training and post-training performance of participants to assist in identifying which training tutorials are having the greatest impact.

In some embodiments, behavioral data is pulled into the learning management system so that the machine learning model can utilize text mining to further isolate the specific training that would be most effective at driving improved performance. For example, a participant that is identified as having low performance to goal in Broadband sales, who also is identified as struggling with key behaviors that are related, such as, asking qualifying questions or explaining benefits of Broadband packages, would have a training tutorial recommended that was tagged with the corresponding, aligned performance metrics and behavioral tags.

In embodiments, a Learning Administration Portal (LAP) contains and applies established business rules that apply to each individual company business unit. This allows flexibility for each business unit to customize their training recommendations to fit their needs, while limiting the disruption of day-to-day operations. Further, this ensures minimal impact to the original recommendations that have been identified by the machine learning model. Examples of business rules include a course completion requirement, a minimum time between repeating completed recommendations, such as 90 days; a target population; an availability of assignment, such as one month; a total number of recommendations of content duration per month, such as 30-minutes; an individual recommendation content length, such as a maximum of 15-min; and tenure requirements, such as excluding new hires from recommendations for first ninety days of employment.

Some embodiments enable rapid content authoring with sharing capabilities via a Learning Content Management System (LCMS). The LCMS allows content authoring, delivery, and the learner to all work in the same platform. This creates efficiencies not inherent with a conventional LCMS. The LCMS may also be connected to client data and use tagging and metadata to connect specific content to client key performance indicators. In embodiments, content creators have the ability to rapidly re-use and share micro-learning courses. This capability creates efficiencies not seen with a conventional LCMS.

Learner interaction data from within micro-learning courses is used in some embodiments to measure effectiveness of the content and associated learning elements. For example, it may be determined if a learner performs better on a certain key performance indicator when the learner engages with a section of content for a certain amount of time. Informal learning interaction data that is collected from a knowledge base may also be analyzed in order to further improve machine learning recommendations and creation of content to match individual employee needs. For example, search trends by topic, keywords, job type, etc. may be analyzed along with associated performance metrics to determine if learners are seeking information outside of the formal learning process. This analysis can be used to inform business unit leaders, training consultants and training design, and data scientists on what information matters most to learners and where gaps may exist in current content and models.

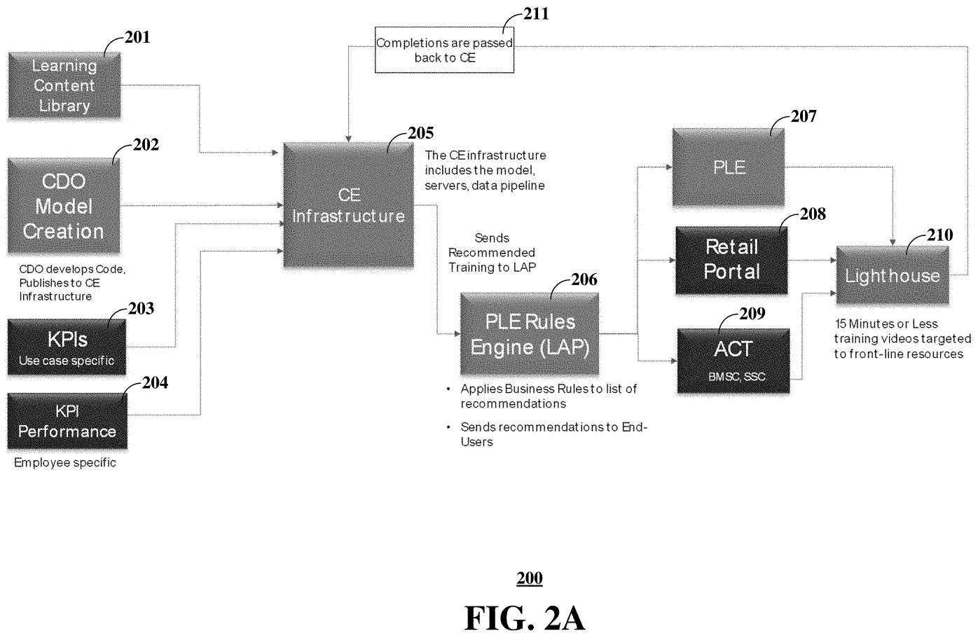

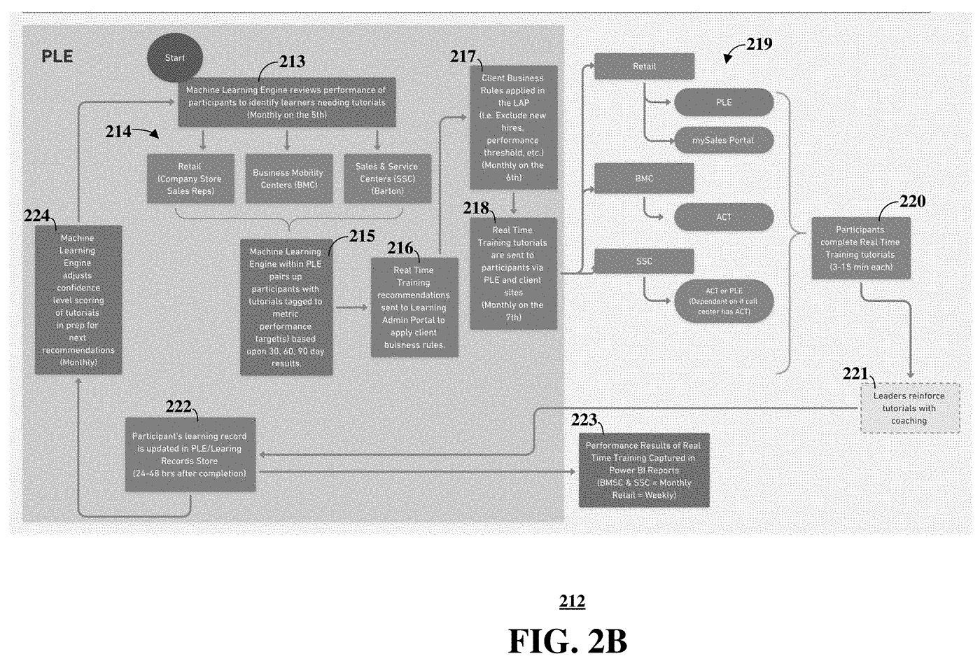

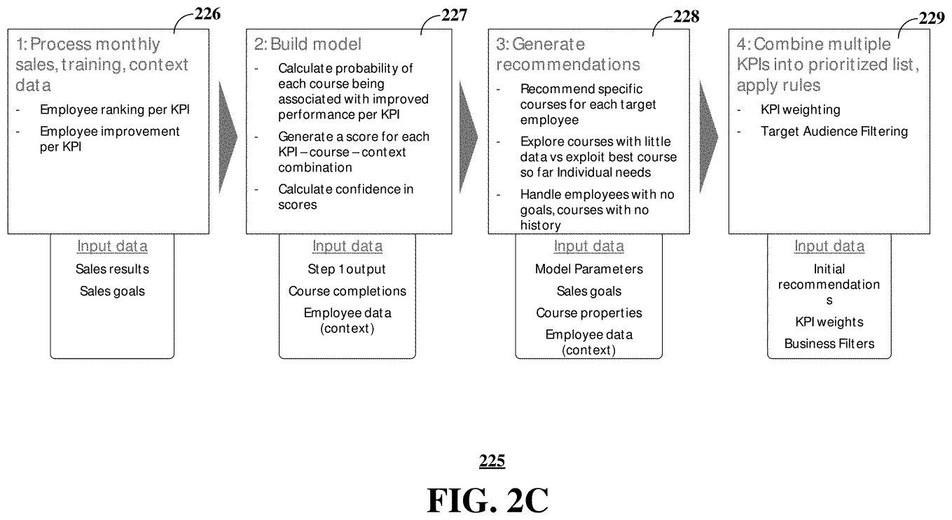

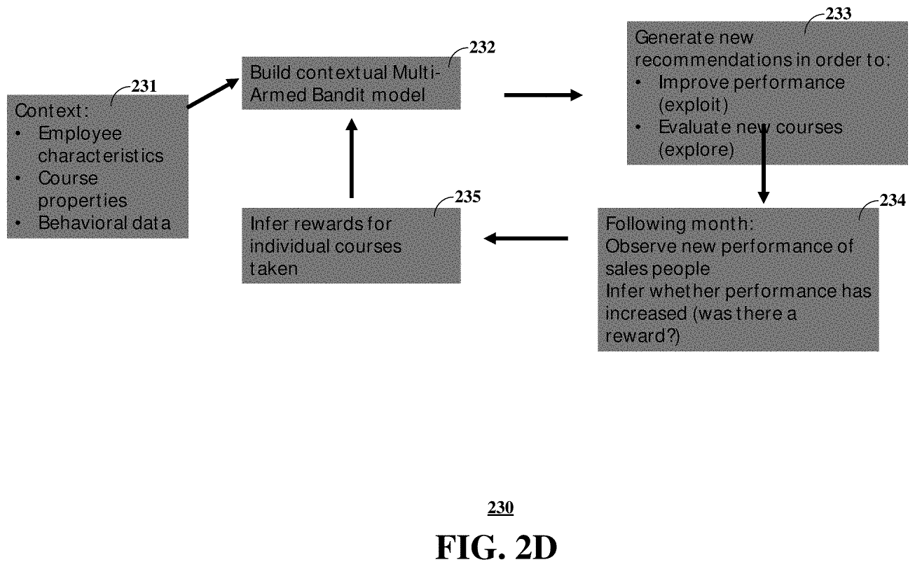

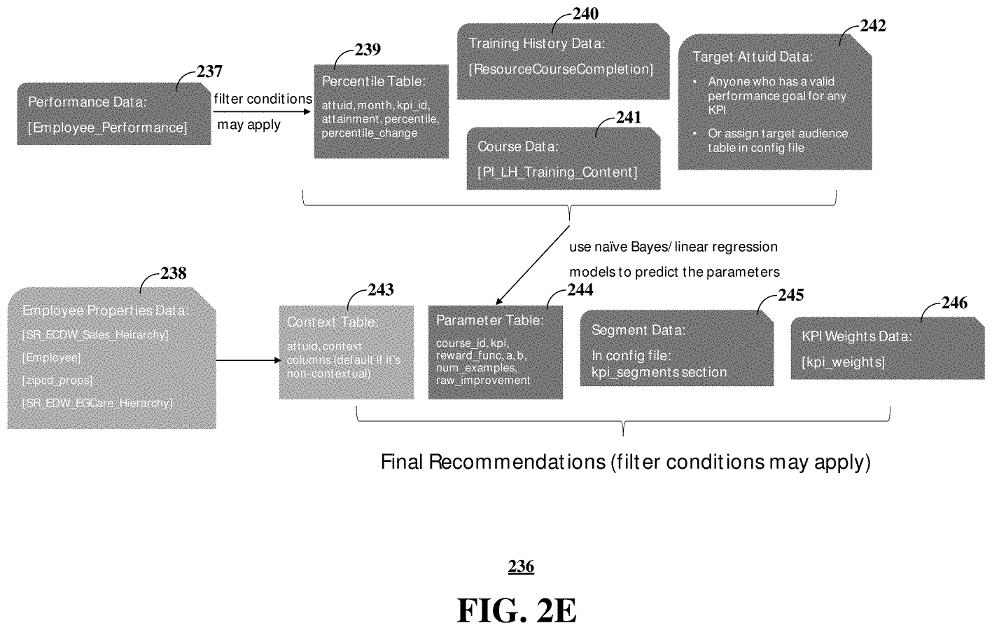

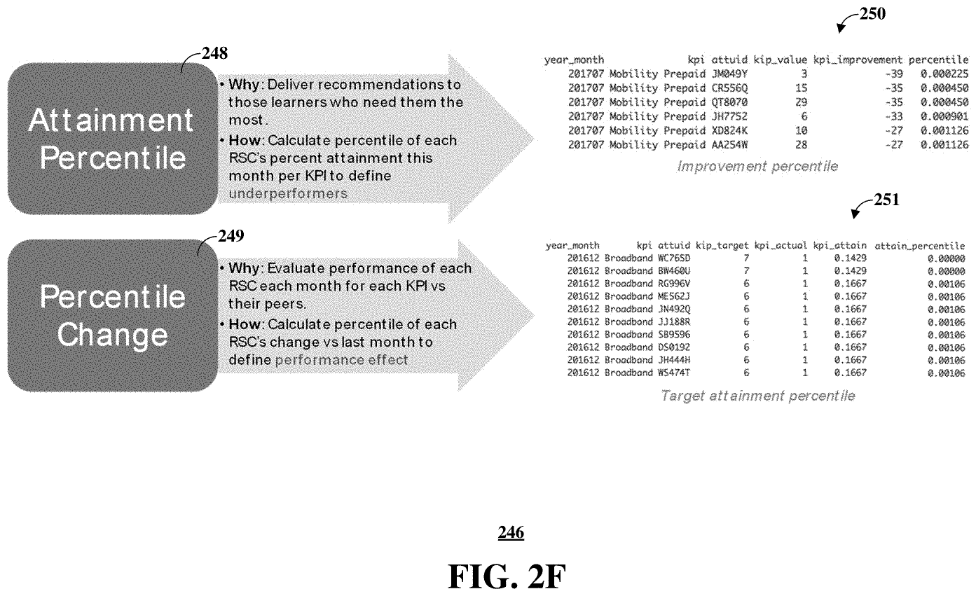

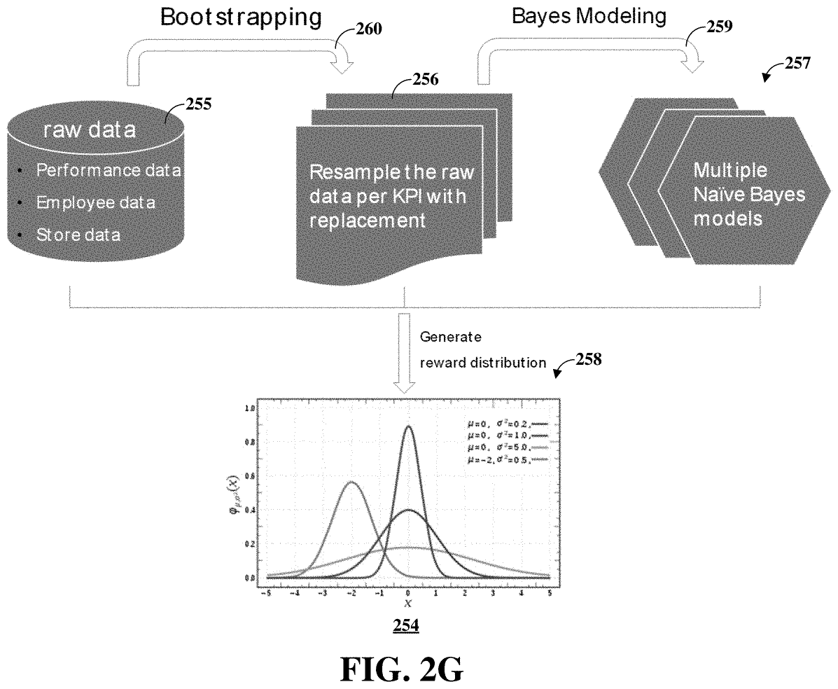

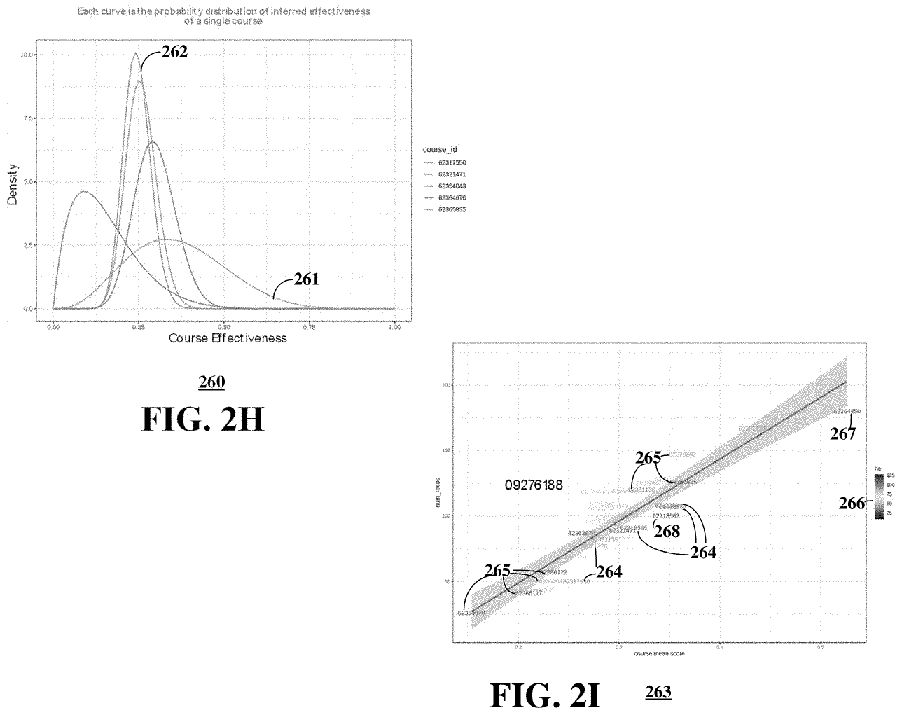

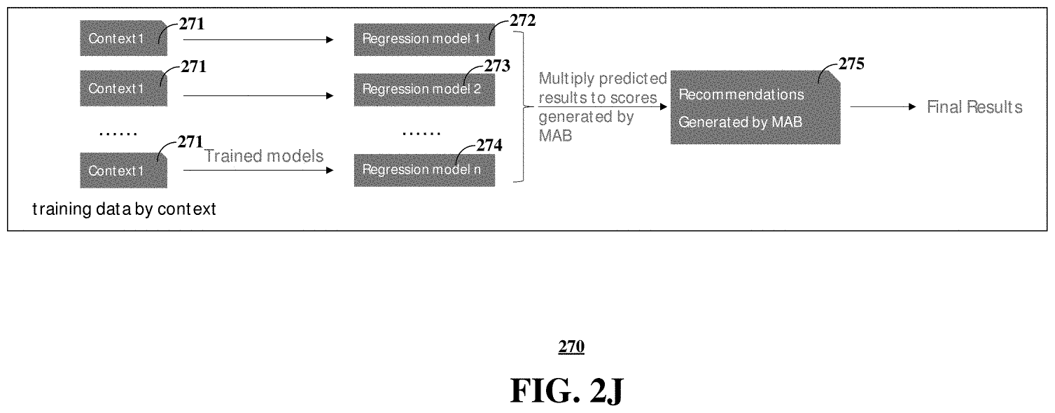

FIG. 2A is a block diagram illustrating an example, non-limiting embodiment of a real time training system 200 functioning within the communication network of FIG. 1 in accordance with various aspects described herein. Embodiments in accordance with aspects described herein provide for individualized training for learners including employees and others, regardless of task performed. In particular embodiments described herein, examples involving training for a worker are used to explain various aspects. However, the techniques may be applied to the widest variety of training and learning requirements. The training may be closely focused on one or more particular aspects of a learner's tasks and be limited in duration to, for example, no more than 15 minutes, and may be referred to as micro-learning. The training is recommended to the learner based on data collected about the learner's performance.

Conventional training arrangements in, for example, the employment context have relied on a supervisor to identify an employee's deficiency. Employee performance can be quantified and collected as data, but a supervisor was required to review the data and decide what training was required. Further, conventional training is focused on training a group of learners in a particular, scheduled course. Once a supervisor identifies an employee that needs training, the supervisor must wait until a scheduled course becomes available or until a large enough group, such as ten employees, are deficient in their performance to justify the group training program. Such conventional training arrangements are very inefficient and difficult to manage.

Training is expected to align to client performance, but there conventionally has never a clear way to draw that connection. Efforts to do so in the past continue to come up short. Established techniques such as Level 4 in Kirkpatrick's Four-level Training Model and Return on Investment analysis hit regular obstacles in establishing correlations to post-training performance. This results in over-training or under-training and the associated costs from either wasted expense or under-performance on the job. Historically, training solutions have been built to cover large homogenous audiences, without care for individual needs and differences. The manual intervention needed to prescribe training at the individual employee level based on specific key performance indicators without automation and machine learning is extremely cost-prohibitive and not easily replicable.

In accordance with some embodiments, micro-learning courses that are shown to improve specific Key Performance Indicators (KPIs) are automatically sent and recommended to individual employees within an organization that are failing to meet desired outcomes within those performance indicators. The KPIs are defined by the organization such as employer. Each KPI reflects a particular functional aspect of the role of the employee in the organization. Each KPI may be defined by one or more data points which can be collected automatically during performance of the role of the employee. KPI can be collected and stored for subsequent processing.

After training by the employee, data is collected and analyzed to identify which courses are impacting performance the most. Confidence scores for the most impactful courses increase and as a result are recommended more often. In addition, this analysis will lead to identification of design elements within individual micro-learning courses that have the greatest and least impact on performance improvement. This may be used to improve course design.

Other analytics include individual learner interactions within a micro-learning course. One example includes determining how long a learner spends on a particular element of a training course and whether there are correlations to training quiz scores or post-training performance impact based on any of these interaction trends. Machine learning models may be created to be flexible and used across similar and different business units, such as sales, service, technical and non-technical functions within an organization. The ability to dynamically assemble the most effective micro-learning courses into more robust training paths that can be leveraged beyond performance improvement to more effectively onboard new employees and improve skills of existing employees that need to gain new knowledge. Some embodiments enable incorporation of behavioral data into data modeling in addition to KPIs and other data sources available. Examples of behavioral data may include on the job observation results and scoring components from quality assurance reviews. In some embodiments, key performance indicators may be weighted based on current objectives of a business unit or other organization. Subsequently, the specific courses and frequency at which they are recommended to employees may be based on these weightings. As a result, training is proportionately focusing in areas that contribute the most to employee and business unit success.

FIG. 2A is an example embodiment of a real time training system 200. The real time training system 200 may be implemented by or in conjunction with one or more components of the system 100 of FIG. 1. For example, learners may access training information using devices such as data terminals 114 via broadband access 110 or mobile devices 124 via wireless access 120. Functionality of components of real time training system may be provided by, for example, network elements 150, 152, 154, 156 and other components as well. The real time training system 200 in an embodiment includes a learning content library 201, a model creation module 202, key performance indicator libraries 203, 204, learning system infrastructure 205, a rules engine 206, personal learning application 207, a retail employee portal 208, a support employee portal 209, a training content database 210 and completions collection module 211. Embodiments of the real time training system may be employed by an organization such as a business, government agency or educational establishment to provide training to learners operating within the organization.

The learning system infrastructure 205 receives input information from the learning content library 201, the model creation module 202, and the key performance indicator libraries 203, 204. The learning content library 201 may include a course content library available for recommendation to learners. The learning content library 201 may store any suitable information about courses and other training materials. In some embodiments, the courses are relatively short in duration, such as 5-15 minutes long and are focused on a very specific training topic, such as identifying customer needs during a sale of accessory devices in a wireless retail environment. The courses may include any suitable type of content items such as video files for display on a device such as data terminals 114 or mobile devices 124 (FIG. 1), web tutorials such as a series of related web pages, text files, audio files, an immersive experience viewable through a virtual reality (VR) headset, and any other suitable format for imparting information to a learner. In embodiments, the courses of the learning content library are all accessible by learners using a device such as data terminals 114 or mobile devices 124 (FIG. 1) so that the content may be accessed by the learner at any suitable time or location. Moreover, the content may be supplemented by features that collect data about the learner's interaction with the content, such as how long the learner spends interacting with the content including total duration, dwell time on any given web page of the content, and other interactions such as mouse inputs. Such data may be processed to determine the quality of the content and the success of the training and may be used to modify content including entire courses of the learning content library 201 or portions of respective courses.

The model creation module 202 generates a machine learning (ML) model. The ML model generates training recommendations for learners using the real time training system 200. In embodiments, the ML model is a contextual multi-armed bandit (MAB) model. In other embodiments, other types of models such as regression models may be used alone or in conjunction with an MAB model.

The key performance indicator (KPI) libraries include a use-case specific KPI library 203 and an employee-specific KPI library 204. The employee-specific KPI library 204 may store information about individual employees or other learners including their role in the organization and data about goals and accomplishments within that role. For example, an employee may serve in the role of retail sales of wireless devices. Part of that role is selling wireless service plans to customers. Employee-specific KPI information for that employee includes the number and type of wireless service plans sold in the past, such as numbers of particular data plans or particular family plans, etc. Employee-specific KPI information for that employee also includes information defining the sales goals set for that individual by a supervisor or the organization, such as number and type of wireless service plans sold in a month or a fiscal quarter. In another example, an employee may server in the role of a warehouse employee. Part of that role is moving packages within the warehouse, such as moving boxes in bulk from a receiving dock to a storage shelf and moving individual product containers for a customer order from the storage shelf to a packaging department. Employee-specific KPI information for that employee includes piece rate or the number of packages moved in a set amount of time.

Similarly, the use-case specific KPI library 203 stores information about functional roles within the organization and data about an employee or other learner performing those roles. For example, a use case relates to service metrics such as reducing a number of times rework is required by a technician involved in installation and repair or provision of a service such as internet service or wireless service. In another example, a use case relates to reducing amount of excess inventory maintained by a business unit. Organizational systems may collect data about inventory levels based on items purchased from suppliers and components sold to customers. A running estimate of on-hand inventory may be maintained. Upon a detection of inventory levels for a particular component exceeding a threshold value, the real time training system 200 may provide to an inventory manager and employees particular training focused on processes such as how to process the excess inventory, including how to return the excess inventory to the supplier. If an activity can be measured and generate data about the measurement about performance, the real time training system 200 can tie the measurement to training. The use-case specific KPI library 203 and the employee-specific KPI library 204 may store information about the measured and goal performance metrics for employee roles throughout the organization.

The learners involved with the real time training system 200 may be involved in any role within an organization. In some applications, such learners are employees of the organization. Generally, the real time training system 200 is well-suited for transactional jobs that generate a lot of data about employee performance. In addition, the real time training system 200 can be applied to any job that has related training and some measurable job performance. Examples include retails sales jobs, where data about job performance may be collected by sales equipment such as handheld devices operated by the retails sales consultants; call center jobs, where data about job performance may be collected by the call center equipment; service technician jobs where data about performance may be collected from a variety of sources. The real time training system 200 can be extended to any role that generates ratable outcomes.

In a further example, the real time training system 200 can be applied to employees in a warehouse context. Such employees may be provided with personal handheld devices which indicate where materiel should unloaded and stored, where orders should be filled and with what items. Further, such employees will generate data related to the accuracy of their work and the time required to complete tasks. Such employees are currently evaluated on a rate of work performed. However, additional data can be collected about worker performance and used to recommend training for the warehouse workers. Subsequently, the effectiveness of the training can be judged and additional training recommended, if necessary, or the training modified.

The learning system infrastructure 205 may be embodied as a server which receives the inputs from the learning content library 201, the model creation module 202, and the key performance indicator libraries 203, 204. In embodiments, the learning system infrastructure 205 includes the ML model, one or more servers and a data pipeline for communication of data. The learning system infrastructure 205 uses the ML model, the KPI information from the KPI libraries 203, 204, and the course catalog from the learning content library 201 and develops a training recommendation for a learner. For example, the learning system infrastructure 205 receives metric information about a learner, such as from the employee-specific KPI library 204. The learning system infrastructure 205 uses the ML model to match the metric information to the learning content of the learning content library 201. The learning system infrastructure 205 may produce as an output a recommended list of courses or other content for the learner, based on the input information received. The learning system infrastructure 205 may provide any other suitable or useful information as an output as well.

The rules engine 206 receives the recommendation from the learning system infrastructure 205. The rules engine 206 applies a set of business rules to the list of recommendations. The business rules may originate from any suitable source, such as business units responsible for an aspect of a business or other organization. In an example, a business unit may conclude that employees within that business unit should take no more than one hour of training in a specified time period, such as one month. In another example, a business unit may prefer that a specified course not be recommended after a set amount of time, such as a course targeted to new hires that may not be appropriate for longer tenured employees. The business rules may be received from any appropriate source and specified in any suitable manner for application by the rules engine 206. The rules engine 206 may be implemented in the same server or other data processing system as the learning system infrastructure 205 or in another data processing system in communication with the learning system infrastructure 205.

Thus, the rules engine 206 receives a raw list of course recommendations from the learning system infrastructure 205 and applies one or more business rules to the list of course recommendations. This operates to filter the recommended course and generates recommended training for a learner. In an embodiment, the rules engine 206 produces a final list of course recommendations and other training information for a learner. The recommended training is provided to systems where the learner may access the training materials.

Learning systems by which a learner may access recommended training include the personal learning application 207, the retail employee portal 208 and the support employee portal 209. The personal learning application 207, the retail employee portal 208 and the support employee portal 209 represent various web access platforms that a learner within the organization can access for employee functions including training, depending on factors such as the business unit within which the learner is employed. The learner may engage with one or more of the learning systems and review the recommended training. In some embodiments, the learner may access a web application on a device such as a laptop computer or mobile device to review a set of clickable links representing the list of recommended courses. In some embodiments, the learner may access the recommended training using the same personal device, such as a handheld device, used by the learner during performance of the learner's job and from which the learner's performance data is collected. This enables the learner to access the training at any suitable time and location, including at the work site or within the work environment. This ensures timeliness and applicability of the training to improving the learner's performance.

Selecting a link, or by accessing an item of the list of course recommendations in any suitable manner, will cause the device of the learner to access the training content database 210. For example, clicking a link corresponding to an item on the list of course recommendations will open a browser tab and provide the training content to the learner. The training content may include any suitable information in any suitable format, including web pages, video, audio, text, immersive content and others.

In some embodiments, training materials may be prepared in a variety of formats, including text, web pages, interactive web pages, video, video files that may be inserted in a web page, audio, immersive learning system and others. When a training item is recommended to the employee, the recommendation may include and be based on information about what format the training materials should be embodied in. For example, if the machine learning model determines that, for a particular learner, a particular instruction format produces best results, the ML model may make a recommendation for format. Some individuals learn best with interactive materials. Some learn best with audio materials. The recommendation may be based on the past experience with the learner and performance data collected for the learner for different types of learning formats. In fact, the ML model may use the multi-armed bandit model to explore and exploit different learning formats for the user. When a training course is recommended, the learning system infrastructure 205 may dynamically assemble content for the particular learner. This may include, for example, combining video files with web pages and quizzes based on past performance data for the learner.

In some embodiments, the learning training recommendation system including the ML model may be predictive in nature, such as in advance of a learner experiencing a drop or reduction in performance. For example, the ML model may have access to a worker's schedule of work to be done. If that schedule includes tasks where the worker or other workers have failed or experienced poor performance, the ML model may schedule training for that worker before the actual work is scheduled. An example is a technician that does work in the field and there is a potential safety hazard with an upcoming job on their schedule. The safety hazard may be indicated in any suitable manner, such as based on other workers' past experiences and reflected in the performance data collected for the other workers. Through training recommended by the system 200, the technician may be reminded of particular procedures or additional procedures to perform, or hazards to avoid, based on the past performance data and the current work being performed.

In another example, training may be customized for workers that need to drive as part of their role. Training may be provided to such workers using a driving simulator, and performance data may be collected about a particular worker's driving performance when driving different types of vehicles, in different types of traffic, in different types of weather, for example. The performance data may be collected from the driving simulator and from actual vehicles driven by the worker. Further, current traffic data may be collected, including for the particular route or region where the worker is about to drive. Any other suitable data, such as current or predicted weather data or accident data or information about the type of vehicle being used for the task, may be collected and used by the ML model to develop a training recommendation for the worker. The training may then be delivered before the worker begins the task so that the training is timely for the worker. As the task is performed, performance data may be collected and used by the ML model for future recommendations for the particular worker and for other workers.

Upon completion of a training item, information about the completion of the training is collected and reported by the completions collection module 211. The information may include any suitable information, including the time and location of completing the training, information about learner engagement with the training materials, such as a time duration to complete the training, learner attentiveness during the training and results of any quizzes or other tests of mastery of the information. The information collected by the completions collection module 211 is reported to the learning system infrastructure 205 as an input to the learning system infrastructure 205.

In some embodiments, the information about the completion of the training is used to determine the effectiveness of the training. For example, the information about the completion of the training may be used to determine that the learner has mastered the training and that no further training on that topic is necessary. In another example, the information about the completion of the training may be used to determine other areas of deficiency that should be addressed with additional training. The learning system infrastructure 205 uses such information for the learner to modify future recommendations for the learner in a subsequent recommendation process.

In some embodiments, the information about the completion of the training is used to evaluate the effectiveness of the provided training and to modify the training. This is especially effective after multiple learners have completed a particular course and the experience of the multiple learners, as reported in their respective information about the completion of the training, is aggregated and analyzed. In some embodiments, the aggregated information is used to modify the content in the training content database 210. For example, if a series of web pages presenting the content of a specified course is determined to be insufficiently effective for training, the information forming the web pages may be recast as a video or immersive experience to be played to future learners taking the course. In some examples, web pages may be automatically modified or reordered or replaced based on the information about the completion of the training and a replacement content item may be stored in the training content database 210 for use by future learners. This modification of the content may be done by the learning system infrastructure 205 or by any other suitable device or system, including by human intervention. For example, the learning system infrastructure 205 may recommend that content presented in a course in a set of linked web pages be instead presented as a recorded video of a human presenter. Subsequently, after recording and preparation of the video by a trainer, the video may be added to the training content database 210 for access by future learners based on recommendations of the learning system infrastructure 205 and the rules engine 206.

In another example, training content presented to learners may include one or more tests or quizzes to collect information about the successful training of specific aspects of course content. The tests or quizzes may be presented in any suitable form including multiple choice questions and games employing visual or audible aspects for engagement by the learner. The results of the tests or quizzes may be collected by the completions collection module 211 and aggregated for multiple learners and used by the learning system infrastructure 205 or another device to modify and improve the training content.

In another example, the learning system infrastructure 205 may aggregate the information about the completion of the training from the completions collection module 211 for a respective learner and adapt recommendations to that respective learner. Adaptations may include changing the format of the training, changing the time duration of the training and changing the content of the training. The modification may be completed automatically, such as by the learning system infrastructure 205, or manually through human intervention. A modified course may be added to the learning content library 201 or the training content database 210. For example, after evaluating the effectiveness of training for the respective learner, it may be concluded that the learner does not learn best using web-based materials but learns better using a combination of video materials coupled with quizzes or tests for reinforcement. Subsequently, the learning system infrastructure 205 generates recommendations for training for that learner using that conclusion. Future recommendations by the learning system infrastructure 205 will emphasize course content that uses video presentations and quizzes or tests.

FIG. 2B is a flow diagram illustrating an overall workflow 212 for a real time training system and method in accordance with various aspects described herein. The workflow 212 may be implemented in any suitable data processing system such as a server including a processor and memory and in data communication with a network to receive information from other systems. In the example of FIG. 2B, the workflow 212 is implemented in the context of a business organization providing sales and service of mobile telecommunications products. More particularly, the workflow 212 illustrates an embodiment of a system and method for determining required training for employees in such a business organization and providing appropriate training to such employees. However, the techniques illustrated in this example can be extended to any individual performing any role in any organization after tasks associated with and performed by that individual in that role are identified and quantized and data is collected for the individual over a time period.

The method begins at step 213 in which a machine learning engine retrieves performance data for employees and identifies learners needing additional training in their job tasks. The performance data may be collected and retrieved for employees performing a variety of functions in different divisions 214 of a business organization. In a mobile telecommunications organization, such divisions include retail stores employing sales representatives for providing telecommunication services and equipment to individuals, business mobility centers for providing telecommunication services to business customers, and sales and service centers.

In general, substantial performance data may be collected for employees in particular roles. Supervisors or management of the organization must identify and assign value to tasks of individuals that are important to the mission of the organization. Specific tasks for each role may be identified and performance of those tasks may be measured over time to develop a metric. The tasks may be key performance indicators (KPIs) for the individual or the organization. For example, for employees working in a retail sales location with a role of sales associate, the role may have assigned tasks of selling mobile phones, selling accessories for mobile phones, selling rate plans for mobile phones, responding to inquiries from walk-in customers, responding to queries from telephone customers, and others. Each task for such a role may be assigned a value based on any relevant factors. Examples include a number of mobile phones sold in a month, amount of time required to complete a sale, and others. The value associated with a task may in turn be a constituent of the performance data for that individual in that role. Further, performance data may be weighted to reflect a relative importance of the task or the role. For example, if during a particular time period, the telecommunications company is emphasizing sales of phone accessories, the data for such sales by employees may be weighted accordingly to reflect the importance associated with that task.

Collecting performance data for individuals is an ongoing process throughout each day, week and month of the year. At step 213, the machine learning engine may retrieve that performance data to identify training needs for individual employees. In the illustrated example, the performance data is collected on the fifth day of each month.

At step 215, the machine learning engine processes the performance data to identify training requirements for employees. The identification of training requirements may be based on the performance data for each respective employee for the current time period, such as the current month. Performance data for additional time periods may be used as well, such as previous months. As indicated in FIG. 2B, performance data for the past 30, 60 and 90 days may be used by the machine learning engine. Further, the machine learning engine may weight performance data according to relative importance or to achieve other goals or to uncover particular trends in the performance data. The performance data includes information about KPIs and the employee's success at meeting the KPIs for the employee in that role in the organization.

At step 215, the machine learning engine further uses the performance data to locate one or more training items for employees. Training items may include courses, tutorials and other materials that may be recommended to an employee. Generally, the training items relate to a deficiency detected by the machine learning engine in the employee's performance as reflected in the employee's performance data. For example, for an employee in a retail sales location, performance data may include a number of mobile phones of a certain grade sold to customers over the last three months. The number of phones sold may be compared to any standard or threshold, such as a sales goal created by management or compared to other similarly situated employees in similar retail locations. For example, performance of employees in stores in rural, suburban and urban locations may be compared to identify deficiencies.

The training items may be in any suitable format. In a particular embodiment, the training items are in the nature of information and data that may be interacted with electronically by the employee using a user device such as a laptop computer, a mobile phone or a tablet computer. Examples include web tutorials which include a number of web pages or video files that may be viewed by the employee completing the training, or audio files such as podcasts that may be heard by the employee. The training items in some embodiments include the ability to monitor and quantify employee interaction with the training items. For example, the training item may report that the employee has completed viewing the training item. In another example, the training item may track user mouse or eye movements during employee interaction with the training item and report information about employee engagement with the training item. In another example, the training item may include a quiz or test to evaluate the effectiveness of the training item. Information about employee engagement and training effectiveness may be reported following completion of the training to judge the effectiveness of the training and to modify the training item if necessary.

At step 215, the machine learning engine matches available training items, such as from a course catalog, according to determined training needs of individual employees. Individual training needs are determined based on KPIs, performance data and other data about the employee, such as employee tenure with the organization or in the role. If the employee is a new hire, or has recently transitioned to the role from another role, the training requirements may be different from those for an employee who has been in the role for a longer time. The employee's tenure in the role will affect the amount of performance data collected and available to the machine learning engine for that employee.

At step 216, the machine learning engine makes real time training recommendations for each employee. In embodiments, the term real time is meant to indicate that the training recommendation is based on current employee performance reflected in performance data for the employee from a current time period, such as the most recent month, two months or three months. Further, the term real time is mean to indicate that the recommended training is made available in the very near future, such as the subsequent month. This is to distinguish over conventional training programs for employees that are responsive to, for example, an annual performance review for the employee and result in the employee being scheduled for training in the future, such as before the next annual performance review in the following year. The real time training is narrowly tailored to the individual employee's training needs, at the current month, based on performance data recently collected for the employee, such as during the past month.

At step 217, the real time training recommendations for each employee are communicated to a learning administration portal to apply any business rules to the recommendations. Business rules may include limitations or requirements that a business unit or any other function within the organization may have established for individual training. Examples include a limit of one training tutorial per month so as to not unduly burden the employee's time. Other examples include rules to exclude new hires from training, rules requiring that an employee achieve a predetermined level of proficiency in a role before qualifying for additional training, or requiring training in a particular task, such as sales of a new model mobile phone, that is to be given business priority in a subsequent time period. Any suitable rules may be applied at step 217. Applying the business rules in this manner may reduce the number of recommended training tutorials and other training items from the list recommended by the machine learning engine at step 216 In the illustrated embodiment, step 217 occurs on the sixth day of the month.

At step 218, real time training materials are sent to employees on the seventh day of the month. This may be done in any suitable fashion. In an embodiment the recommended training items are presented at a web accessible portal accessible by each employee through a user device such as a laptop computer or portable device. The employee may view a web page with training recommendations and information. To access a training item, the employee may click on a link on the web page and the training item is retrieved over a network from a repository such as a data base. For employees in different business units or locations within the organization, in different divisions 219 of a business organization, any suitable portal or access method may be provided.

At step 220, the employees complete the recommended training. The training may be completed in any suitable manner. In an embodiment, training items may be in the form of courses or tutorials that may be viewed and interacted with using a web browser on a computer or portable device. The training items may include features for tracking completion and interaction by the employees. Data about the completion and the interaction may be reported by the training items, for example to the machine learning engine.

In the illustrated embodiment, the training items are relatively small in size and duration and very focused on a particular aspect of training. For example, the training items may be limited to three to fifteen minutes duration. In another example, a training item may be focused on a concise topic such as features of a new product or completing a sale with a customer, or recording details of a new service contract. The training items may be referred to as micro-learning courses. The training items are intended to improve a key performance indicator for the employee.

At optional step 221, the training that is automatically selected and provided at step 220 may be reinforced by a leader such as a supervisor. This may be done in any suitable manner depending on the particular training item, the context and the individual employee and supervisor.

At step 222, a learning record for the employee is retrieved from storage and updated with the results of the training at step 220. Any suitable information may be maintained in the learning record including past performance data, past training courses recommended by the machine learning engine, past courses recommended to the employee and past courses completed. The information may include results of any quizzes or tests included with the training item or administered after completion of the training item. In the illustrated embodiment, this is performed 24 to 48 hours after completion of the training by the employee at step 220. In some embodiments, the training record may be updated within one hour of completion of the training by the learner.

At step 223, performance reports are generated for the real time training system. Reporting may be done according to any suitable schedule such as weekly or monthly. Reports may include any suitable information that may be useful to supervisors or managers.

At step 224, a feedback process is completed using the results of the training at step 220. In an embodiment, confidence level scoring for the tutorials and other training items is updated to reflect the information reported about employee completion of the training items. The reported information may include the time and data of completion. The reported information may include information collected about the employee's interaction with the training materials, such as dwell time on a web page or mousing activities or information about repeated viewing of pages or the entire item.

In an embodiment, the machine learning model adjusts the confidence level score of each individual training tutorial based on the KPI performance of each individual learner post-training. The machine learning model reviews the post-training performance to identify the tutorials that are showing higher levels of positive KPI performance and then adjusts the scoring of those individual courses so that participants that are experiencing similar struggles with KPI performance can benefit from the tutorials that are showing the most significant impact in future recommendations that are made.

In an embodiment, based on the reported information content and format of one or more training items may be manually or automatically adjusted. For example, if employee interaction indicates that a web page of content of the training was not clear, the web page may be rewritten to include different information or to clarify presentation of information. Aspects of web page appearance, such as graphics, text fonts, photos or other material included on the web page may be automatically replaced or updated based on the reported information about employee interaction with the training item.

In some embodiments, feedback may be provided to course content creators. Such feedback may inform the course creators as to how successful their courses are doing for target audiences. In an example, course creators may have access to a dashboard using a computing device. The training system and method may collect data about course effectiveness that may be reported to and accessible through the dashboard. The course effectiveness data may be based on comparisons of learner data before taking the course and after taking the course. Further, the course effectiveness data may be accessible or viewable based on categories of learners or KPI or any other suitable information. The feedback information may be in the form of numerical data or statistics. In other embodiments, the feedback information may be in graphical format, such as bar charts and pie charts or another format that is intuitive and easy to grasp. The feedback information may be in a format through which the course creator can drill down to obtain additional information, such as a bar chart that may be viewed and accessed on a display or touch screen and clicked or selected to display additional levels of detail, all the way down to the hard numbers produced by the training recommendation system. The feedback may also be viewable or classified by format, such as online or a video or audio training, or classified by duration of a class, or by presenter of the training, or channel of presentation such as mobile devices versus a desktop. The feedback may provide the course creators with information about a specific target audience, how effective the course has been and a degree of confidence in that course's effectiveness. The feedback may thus enable a conclusion such as “a learner in population of learners A seems to learn better with shorter-duration content delivered over a mobile device, for example.” This may be useful for revising a specific course of for developing future courses.

Another example of feedback that may be accessed by the machine learning model is feedback from the learners themselves about the quality of the training. The learners may be presented with a survey at the end of the training asking for their opinions about clarity, coverage and other aspects of the training. The opinion feedback may be used to modify and improve the training course. Further, at the end of the training, the learner may be presented with a quiz or test to check the success of the training. Again, the test feedback may be used to modify and improve the training of the course. Further, successful completion of training and improvement of performance may be used to encourage employees to complete recommended training with a message that, of other similar employees who have completed a particular course, their performance improved by a specified amount.

In another example, schedule information for a learner may be accessed and used to recommend training to the learner. For example for an employee who works according to a schedule of appointments, if the schedule shows an empty time with no other task scheduled, the training recommendation system may recommend scheduling for that time and even automatically add the training to the employee's schedule.

In some embodiments, information about performance data may be used to recommend training or job skills improvement technique to supervisors of the employees whose performance data is gathered and evaluated. A machine learning model may operate to match the performance data of the employees the supervisor or manager supervises with recommended training for the supervisor. For example, performance metrics for the employees may be attached to or extended to the supervisor. If there is learning or training available for that next organizational level (supervisor or manager) that correlates to those metrics, such as KPIs, then the training may be recommended to the manager. Such training for a manger might take any suitable form, such as a recommended style of coaching or team activities. The training recommendation system may store data about managerial activities, such as completed coaching by the manager of the manager's supervised employees. The training recommendation system may recommend to the manager a coaching module for additional training on coaching. Such training may help the manager to understand the manager's role in coaching the manager's supervised employees with the job aspects they are struggling with.

After step 224, control returns to step 213 to receive additional performance data for a subsequent month. The workflow 212 for the real time training system and method can be repeated according to any schedule, such as monthly.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C depicts an illustrative embodiment of a recommendation engine 225 for a real time training program in accordance with various aspects described herein. The recommendation engine 225 may be implemented in any suitable data processing system such as a server including a processor and memory and in data communication with a network to receive information from other systems. The recommendation engine 225 enables use of sales performance data and course completion data to make individualized training recommendations for individuals in an organization. The recommendation engine 225 receives data about performance of characteristics of learners and matches the learners with course from a course catalog or other training. The recommendation engine 225 operates based on performance data and what will have the biggest impact on achievement on certain KPIs based on past performance of other people and this person's performance. The output of the recommendation engine 225 include identification of an individual and a stacked rank of recommended training for that individual.

In step 226, the recommendation engine 225 processes monthly sales, training and context data for an organization. While a period of one month is shown in this example, any suitable recurrence time frame may be used. Step 226 receives all performance data, including identification of the learners, information about their assigned roles, such as retail sales in a suburban area, tenure with the organization, sales achievement in the last month. Generally, step 226 involves receiving information about the learner that would change how effective the training courses are. Step 226 also includes receiving information about sales results for the organization the previous month. This includes history sales results per person. This enables the recommendation to understand the individual's performance relative to other individuals. This also enables the recommendation engine 225 to tailor a recommendation for the individual. For example, if the individual is deficient with respect to a particular KPI, the recommendation engine may locate specific training that has proven results to help improve that particular KPI. Other inputs at step 226 may include sales results and sales goals. This enables an analysis of what an individual was able to accomplish versus what he was expected to accomplish. The received data is used to determine performance of the individual over time and performance of the individual relative others performing the same role.

At step 227, a machine learning model is built. In an embodiment, a reinforcement learning model is built and in a particular embodiment, a multi-arm bandit (MAB) model is built to generate training recommendations for learners. A MAB model may be used to resolve a conflict between exploiting courses that are known to produce good results versus exploring the effects of courses with unknown effectiveness. For example, if three courses in a course catalog are known to produce a positive impact on learners and three new courses are brand new and have never been recommended and performance is unknown. The MAB balances learner's time to exploit the known courses while also exploring the untested courses. Thus, the use of a MAB model allows optimizing use of a scarce resource, learners' time, based on past performance.

The inputs to step 227 include the outputs from step 226 as well as information about course completions by learners over the last month, for example, and information about the employees to whom courses will be recommended. Step 227 operates to calculate a probability of each course in the course catalog being associated with improved performance for each KPI and to generate a score for each combined course and KPI. Finally, step 227 operates to calculate a confidence score for each generated score the KPI-course pairs. Step 217 may be part of the development operation of the recommendation engine 225.

At run time for the recommendation engine, step 228 generates recommendations. Input information to step 228 includes model parameters, sales goals, and course properties of courses in the course catalog and employee data. Step 228 operates to generate recommendations of specific courses for each employee. The MAB model enables step 228 to explore courses with little data from past performance versus exploiting known best courses.

At step 229, KPIs are combined. For example, if there are a number of categories or dimensions on which an employee is measured, there is a corresponding KPI for each dimension. Step 229 generates a stacked ranked list, per KPI. Inputs to step 229 include the initial recommendations from step 228, KPI weights and business filters. For the example of a retail sales employee selling telecommunication devices and services, the employee may have performance sales goals of selling one hundred headsets and 25 rate plans in a month. Different training will be targeted to those two tasks of the employee's role and training can be recommended to improve performance at both tasks. However, the organization may have a higher priority for one KPI, such as sales of rate plans. The prioritization of KPIs may reflect business interest or any other factor. Step 229 operates responsive to the prioritization of KPIs to produce a single, blended list of recommendations for each user. Thus in this example, step 229 may produce a recommendation of three courses related to sales of rate plans and one course related to sales of headphones and other accessories.

FIG. 2D depicts an illustrative embodiment of a basic workflow 230 of a multi-armed bandit (MAB) model for a real time training program in accordance with various aspects described herein. The workflow 230 may be implemented in any suitable data processing system such as a server including a processor and memory and in data communication with a network to receive information from other systems. FIG. 2D illustrates that the workflow 230 may be implemented as a continuous, recurring loop with feedback of past results to affect current or future recommendations. On a regular basis, such as monthly, new data is collected and the MAB model is rebuilt.

At step 231, information is retrieved from storage about employee characteristics, course properties and behavioral data. Employee characteristic information may include information about each employee's role in the organization, particular KPIs for that employee, and past or historical performance data, employee tenure and whether the employee was previously an underperformer. Course properties may include information about particular KPIs toward which a course is directed to improving. Behavioral data may include employee performance data for the period under consideration, such as the immediately past month. Other context information may be information about the location of the retail location where the employee works, such as rural, suburban or urban, as well as information about the community where the retail store is located such as demographic data, income data and others.

At step 232, the MAB model is built or rebuilt. Inputs are the context, including data from step 231, and reward information referred for courses taken and received from step 235.

At step 233, new course recommendations are generated for learners. In accordance with the MAB model, the recommendations are generated to improve performance of the learners or exploit the courses in the course catalog or to evaluate the effectiveness of new courses, or to explore the courses in the course catalog.

At step 234, based on the recommendations generated at step 233, employees interact with the recommended training and continue to perform in their roles. As they perform, performance data is collected and performance is observed. Step 234 further include inferring whether performance has increased or improved for specific KPIs, or for the MAB model, determining if there was a reward. At step 235, rewards are inferred for individual courses taken by employees during the last month.

In one particular application, the properties of the MAB model may be used to identify how effective a particular course is for particular learning styles of participants. That effectiveness information can be used to modify the content of the course. For example, effectiveness information may be provided to course content creators to change the course content, such as by adding or deleting or revising the course content. In another example, the course content may be automatically revised based on the effectiveness information.

FIG. 2E depicts an illustrative embodiment of a data flow 236 of a multi-armed bandit (MAB) model for a real time training program in accordance with various aspects described herein. The data flow 236 may be implemented in any suitable data processing system such as a server including a processor and memory and in data communication with a network to receive information from other systems.

The data flow 236 illustrates receipt of two data files, performance data 237 and employee properties data 238. The performance data 237 may be retrieved from any suitable sources and includes information about performance of learners such as an employee or a group of employees. In some embodiments, performance data corresponds to differences between FIG. 2D step 234, which includes observing new performance of sales people for a month, and step 231 which includes initial employ characteristics. A sales database may be accessed to obtain sales data for an employee or other learner. Raw sales data may be used to determine if an employee's sales has gone up relative to other employee sales. The ratio of each employee's sales to total sales may be determined to fill a percentile table 239. The percentile table may be organized according to an employee identifier, designated attuid, and may store information identifying the month for which the data is current, KPIs for which the employee is responsible and other information, a percentile value for the employee's performance for that KPI and a percentile_change value for that employee. Filter conditions may be applied to the performance data 237 to populate the percentile table 239. The percentile and percentile_change values provide an indication of whether an employee's performance has improved in the last month in response to the training the employee has received.

Referring to FIG. 2F, FIG. 2F illustrates some data included in the percentile table 239 in an embodiment. FIG. 2F depicts an illustrative embodiment of a data 246 for measuring effects of a training course and for detecting a performance change for a multi-armed bandit (MAB) model for a real time training program in accordance with various aspects described herein. The data 246 includes attainment percentile data 248 and percentile change data 249.

The training recommendation system in accordance with various aspects described herein measures whether an employee or other learner has improved in performance including with respect to their peers. In some instances, absolute changes in an individual's performance are not a reliable measure, such as a holiday-time promotion when all or most retail sales employees increase. Thus, in the example of FIG. 2F, percentile change data 249 may be used to evaluate performance of each retail sales consultant (RSC) each month, for each KPI, relative to the employee's peers. The employee's peers are other employees who perform the same or similar task, at the same or other locations, and whose performance is measured using the same KPI. Monitoring the data 246 over time for a population of learners permits an inference that a course has helped to improve performance.

The attainment percentile data 248 or percentile data are calculated as a measure of an employee's performance with respect to a particular KPI divided by a goal value for that particular KPI. As indicated in FIG. 2E, the attainment percentile data 248 in the embodiment is determined for retail sales consultant (RSC) employees but the techniques may be extended to any employee or learner. Applying the technique may involve identifying a performance indicator for some function or activity of the learner and quantifying the identified performance indicator. This may be done in any convenient fashion and the data may be automatically collected for the learner. In the case of an RSC in a telecommunication sales office, KPIs of interest may include sales of new mobile phones, sales of data plans, and other performance indicators. Data about such sales may be recorded automatically, for example, as a transaction with a customer is entered into a sales terminal. The relevant data may be selected from sales data and stored in a database of performance data 237 (FIG. 2E) for employees including the RSC. Similarly, goal values for each KPE for each RSC may be established. The attainment percentile data 248 may be obtained by, for example, dividing the RSC's KPI value by the goal value for each KPI for the month or other period. The KPI is identified by an identifier labelled KPI_id. The attainment percentile data 248 may be used to identify underperformers, or employees whose performance does not meet the goal for a KPI. Underperforming may be relevant to other employees or RSCs whose performance is measured for the same KPI relative to a goal for each respective employee or the same goal for all employees. The attainment percentile data 248 may be used to identify employees whose performance will benefit from additional training. Recommendations for courses related to a KPI identified by the KPI_id value may be made based on the attainment percentile data 248 for employees including underperforming employees.

FIG. 2F illustrates an example of an attainment percentile data table 250. The data in the attainment percentile data table 250 is organized according to a year and month for which the data has been collected, a KPI identifier such as “Mobility Prepaid,” an attuid or employee identifier, a KPI value and a KPI improvement value for that employee and that KPI and that month, and an attainment percentile value. The attainment percentile data table 250 in other embodiments may include other data and be organized or calculated in manners different from the example here. In the example, the elements of the attainment percentile data table 250 are sorted by percentile value to assist in determining which employees are underperformers or are most in need of additional training. The individuals most in need of training may be automatically recommended more courses related to the identified KPI to improve performance in the future.

The percentile change data 249 reflect a change in performance for each employee's performance versus the prior month to determine a performance effect. The percentile change data 249 may be calculated to evaluate the performance of each RSC each month for each KPI, relative to the RSC's peers. The peers may include other employees in similar roles in the organization, such as other RSCs responsible for selling telecommunication services and products. The performance of the peers may be measured for the same KPIs in similar fashion, such as based on recorded sales data. A percentile of each RSC's change in performance for the current month versus the performance in the prior month, or any other evaluation period, may be calculated to define a performance effect. This may help to eliminate seasonal noise or fluctuation in the performance data for employees. For example, when a new product is released, customer enthusiasm for the new product may cause each employee's KPI data to increase for a given month so that all employees score better for the month. Calculating the percentile change removes or smooths out the seasonal change and permits accurate comparison of an employee's KPI data with peers' data. This compares the employee's current performance to their last performance to eliminate the seasonal impact on the model.

FIG. 2F illustrates an example of a percentile change data table 251. The data in the percentile change data table 251 is organized according to a year and month for which the data has been collected, a KPI identifier such as Broadband, an attuid or employee identifier, a KPI_target value for the KPI and the employee, and a KPI_actual value for the KPI for that employee, indicating the actual value measured during the month for the employee. The data in the percentile change data table 251 further includes a kpi_attainment value and attainment_percentile value for each entry. The percentile change data table 251 in other embodiments may include other data and be organized or calculated in manners different from the example here.

Other data sources collected for the MAB model include training history data 240, course data 241 and target learner identification data 242. The training history data 240 records information about what training courses each employee has taken in the past. If an employee has completed a training course in the last month. If the employee completed one or more courses and performance data shows an improvement in employee performance, the MAB model can link the improvement in performance to the training that was completed. The training history data 240 also allows the machine learning model to understand if a particular tutorial has been completed for a learner that may still need improvement in a particular KPI. If the learner still needs improvement in that KPI, and has completed the previous recommendation, the machine learning model will then look for additional content that is tagged for that KPI or is pertinent to that KPI and has a high confidence score from other participants that have completed that tutorial and seen improvement.

The course data 241 records properties of each respective course in the course catalog. The target learner identification data 242 records employees to whom training courses may be recommended. Such employees may be identified by any KPI assigned to them. For example, if an employee has a performance indicator related to product sales that is tied to the employee's performance review, that employee may be a candidate for training to improve performance. Also, in a pilot program to test certain aspects of the disclosed system and method, such employees may be targeted to participate in the pilot program. The target learner identification data 242 identifies employees that are actively in the recommendation system.

The recommendation system in the illustrated embodiment includes four inputs, a context table 243, a parameter table 244, segment data 245 and KPI weights data 246. The employee properties data 238 includes information about each employee to whom training may be recommended. Examples of such data include the role assigned to the employee, the tenure of the employee, or the time during which the employee has been engaged in the present role, the location such as postal code where the employee works including data about that location such as a rural, suburban or urban descriptor, and so forth. The employee properties data 238 may be used to populate a context table 243 which organizes the employee data according to an employee identifier designated attuid.

The context table 243 represents different ways employees can be grouped together. For example, if the employee properties data 238 categorizes employees according to location and has two possible values, suburban and rural, and categorized employees according to tenure and has two, values, new and experienced, the combination of the categories creates four different contexts in which employees may fall or be grouped. The employees will be considered in the MAB model will be considered according to the categorization and training will be targeted according to such categorization. Thus, one example of targeting training will be to target certain courses to new employees in suburban locations.

The information of the percentile table 239, the training history data 240, the course data 241 and the target learner identification data 242 may be processed to predict parameters for the MAB model. In one example, a naive Bayes model may be used to predict the parameters of the parameter table 244. In another example, a linear regression model may be used to predict the parameters of the parameter table 244. The context table 243, the parameter table 244, segment data 245 and KPI weights data 246 are used by the MAB model to develop final course recommendations for employee training.

The segment data 245 is another input to the MAB model. For some applications, employees and other learners may be segmented by organization or other factor. In one example, the set of employees includes call center employees. Different training content may be prepared for each call center. Each call center may be assigned to a different segment and training content may be recommended according to segment or call center. Using segments as an input to the MAB provides better control over assignment and recommendation of training. Any suitable segments may be defined according to any purpose of the organization or roles of the learners.

The KPI weights data 246 may include information defining a relative weight or value or importance of particular KPIs. The organization may emphasize particular KPIs for a particular business purposes. Weights of particular KPIs may be increased or decreased over time to reflect the business purpose. For example, the organization may encourage employees to sell more data plans this month in retail locations. To reflect this marketing or business purpose, and to properly track and credit employee efforts and success directed at that business plan, the KPI weight data 246 may be adjusted and applied to the MAB model. The following month, if the emphasis on data plans is changed, the KPI weight data 246 may be readjusted accordingly.

The context table 243, the parameter table 244, the segment data 245 and the KPI weights data 246 are inputs to the MAB model. As indicated in FIG. 2E, the MAB model generates recommendations of training for learners including employees. Some additional filter conditions may be applied. For example, some organizations may apply particular rules or filtering to limit recommendations to courses. The filtering may include the rules engine 206 FIG. 2A that applies a set of business rules to the list of recommendations produced by the MAB model. For example, if a course has been recommended to an employee in the past 90 days, according to a business rule, the course may not be recommended again.

The MAB model is a way to determine for a particular employee whether a particular course helps learners like the particular employee, and if so, how much does it help such learners, and a degree of certainty about that conclusion. If the degree of certainty is relatively low, the course may be assigned to relatively more learners to develop more certainty rather than to maximize performance. If the degree of certainty is relatively high, the course may be assigned to relatively more learners to maximize performance by training with the most effective course. This corresponds to the explore-exploit tradeoff of the MAB model.

Referring to FIG. 2G, it shows a conceptual diagram for measuring effect of training courses using naive Bayes modeling with bootstrapping. The process of FIG. 2G may be used to establish causality between training and improvement in performance. FIG. 2G illustrates a process 254 to generate input parameters for the MAB model. In particular, FIG. 2G illustrates parameter generation using a naive Bayes method with bootstrapping. The process 254 accesses the raw data 255 and performs resampling of the raw data, per KPI, with replacement, step 256. Multiple naive Bayes models 257 are generated. The raw data includes, in an example, performance data 237 (FIG. 2E), employee properties data 238 and store data about retail locations. Other data may be used in other embodiments. In the example embodiment, the expected output reward distribution 258 is the probability distributions of reward for each context per KPI per training course. The probability distribution provides an indication of the likelihood of receiving a reward, given a particular context as an input. Input contexts include categories such as tenure of an employee and a rural or suburban work location of the employee. The number of contexts is the product of the possible context categories.

A Bayes modelling process 259 generates multiple naive Bayes models 257. The naive Bayes models 257 use conditional probability to calculate probability which serves the situation. In an example, the naïve Bayes modeling predicts the probability that taking a course puts the employee into the most improved category, such as percentile change greater than or equal to 0.75. That is, given an employee in a given context, if the employee takes a specific training course related to a specific KPI this month, determine the probability that doing so will put the employee into the most-improved category next month. The result, given multiple contexts and multiple KPIs, is a set of multiple naive Bayes models 257. The most-improved category may be defined in any suitable way. In an example, the most-improved category is defined as percentile change greater than or equal to seventy-five percent.

As illustrated in the example, a bootstrapping process 254 uses random sampling with replacement to solve a problem of lack of training data to generate the reward distribution 258. When the recommendation program for recommending training is initiated, there is little or no training data available including performance data and training history data. This may be referred to as a cold-start problem. In an example, the process samples data, step 256, from a data set such as the raw data 255. The strategy is, every time, a number of random data items are drawn from the pool, they are returned to the data set. Subsequently, a random data item is draw again. The process of resampling the raw data, per KPI, with replacement, of step 256, addresses the problem of lack of training data.

The reward distribution 258 is a normal distribution. The reward distribution 258 is an example input to the MAB model.

Naive Bayes modeling is used to predict the probability, with some conditions, that taking a course will improve the performance of an employee for a specific KPI. A naive Bayes classifier is a simple classifier that has its foundation on the well-known Bayes theorem which relates two conditional probabilities as follows

$$( Independent variables )$$

$$P ( A ⋂ B ) = P ( A , B ) = P ( A ) P ( B \vert A ) = P ( B ) P ( A \vert B ) ⟹ P ( B \vert A ) = \frac{P ( B ) P ( A \vert B )}{P ( A )} == > P ( {C}_{k} \vert {x}_{1} , {x}_{2} , {x}_{3} , … , {x}_{n} ) = \frac{P ( {C}_{k} ) P ( {x}_{1} , {x}_{2} , … , {x}_{n} \vert {C}_{k} )}{( P ( {x}_{1} , {x}_{2} , … , {x}_{n} )}$$

In an example embodiment, x₁, x₂ . . . xₙ represent the taken course A, taken course B or other course category, fall into locations or other location category, fall into underperformer or fall into new employee or other employee category. P represents the probability that, given all the above situations or contexts, performance for a KPI would be improved, assuming percentile change is top 25%. Thus the value range for P is from 0 to 1.0.

As noted, bootstrapping resampling may be used. In order to calculate the probability distribution, the data are resampled to generate different outputs from naïve Bayes models and compute the mean (μ) and standard deviation (σ) for a Multi-Armed Bandit model input per context combination. Note that an important assumption of using Bayes theorem is that every variable in the model is independent. In some examples, imperfect results may be experienced in practice since some variables are not independent in the real world.

FIG. 2H is a plot 260 of calculated course effectiveness in accordance with various aspects described herein. In FIG. 2H, several curves are illustrated. Each curve is the probability distribution of inferred effectiveness of a single training course. The curves are the output of the naive Bayes model and the input for the MAB. The abscissa represents course effectiveness. The ordinate represents density. The curves are normalized so that the area under each curve is equal to 1. Course effectiveness refers to the probability that taking the specified course will give an employee an improvement. A value of 1.0 indicates a definite improvement. A value of 0 indicates no improvement.

Consider a first course corresponding to curve 261. The range of the course is relatively wide, indicating that the recommendation system has relatively little knowledge about the effectiveness of the course. In contrast, consider the course corresponding to curve 262. The range of curve 262 is relatively narrow, indicating a higher degree of confidence that the course will give some degree of improvement. The probability of improvement is generally in the range of 0.2 to 0.4.

In an embodiment, the MAB model is implemented with Thompson Sampling. In Thompson Sampling, a random number is drawn from each distribution P(effectiveness) and the highest value is chosen. The MAB model with Thompson sampling gives a balance of explore versus exploit. Some courses are known and there is substantial data with respect to how effective the courses are and can be exploited to produce good results. Some courses are new and untested and need to be explored as to effectiveness by recommending them to some learners. Thompson Sampling involves drawing a random number and determining which curve gives the best result for that random number. Then, the training course associated with that curve is the recommended training course. This provides a good balance of exploit versus explore. For example, in FIG. 2H, a random number of 0.6 would indicate that curve 261 has the highest value of density. Therefore, using Thompson Sampling, the training course associated with curve 261 would be recommended. In contrast, while the curve 262 has a relatively high peak value, the range of curve 262 is relatively narrow so that the likelihood of curve 262 providing the highest value when a random number is drawn is low. In some cases, multiple courses are to be recommended so three random numbers are drawn to generate the multiple recommendations.

The example of FIG. 2H is for non-contextual bandits in an MAB model. The context for the MAB model is a set of descriptors about the current state. For contextual bandits, curves on a plot such as the plot 260 of calculated course effectiveness are conditioned on context: P(effectiveness I context). A machine learning model, such as a regression model, may be used to infer parameters of conditional distributions from a history of actions and successes.

FIG. 2I is a plot 263 of outcome of Thompson Sampling for a MAB model in accordance with various aspects described herein. The plot illustrates the success of the explore-exploit tradeoff for the MAB model. Each respective course is illustrated as a course number in the plot 263. The abscissa corresponds to the course mean value. A larger mean value for a course corresponds to a course that is relatively effective at improving an employee's performance. The ordinate corresponds to the number of recommendations made for a course at the course mean score. The data may also be presented by assigning a color to the course number on the plot 263 where the color corresponds to the number of times the training course has been taken by learners. Thus courses 264 are colored at various shades of blue to illustrate that a relatively large number of learners have taken those course and courses 265 are colored at various shades of red to illustrate that a relatively small number of learners have taken those courses. A legend 266 relates number of courses taken (ne) to the color in the plot 263. Thus, the blue colored courses 264 have a higher degree of confidence or are more statistically significant. The red colored courses 265 have a lower degree of confidence or are less statistically significant.

One interpretation of the plot 263 is that the number of recommendations for a particular course (num_recos) is higher if the course is considered effective and if confidence in that course is less. Thus, a lot of red course numbers (relatively fewer data points) are above the blue course numbers (relatively more data points). This illustrates the tradeoff of explore versus of exploit, and how much the system leans toward exploring new courses versus exploiting known courses.

In the plot 263 of FIG. 21, the course mean score is increasing as the number of recommendations increases. Consider course 267, located near the upper right of plot 263. Course 267 is shown in red indicating it has been taken by relatively few learners and that confidence is low as to whether the course will improve performance. Because the confidence is low, the recommendation system has recommended the course 267 relatively more times to explore the effectiveness of course 267. As a result, the course 267 is located relatively high on the abscissa.

In the plot 263, course 268 is shown in blue, indicating a high degree of confidence in the effectiveness of the course. The course 268 is down and to the left on plot 263 compared to course 267 because confidence in the course is higher. Course 268 is a course that will be exploited less, relative to course 267 that will be explored more and recommended more.

FIG. 2J is a flow diagram 270 illustrating an enhancement to a MAB model in accordance with various aspects described herein. In particular, FIG. 2J illustrates use of a booster layer in addition to a MAB model for use in a training recommendation system.

The use of the booster layer operates to incorporate performance metrics. This can include objective data collected automatically by a performance monitoring system. Incorporating performance metrics can also include subjective information provided based on a human observation of an employee's performance. For example, in some call centers, a tool is used to convert audio recordings of customer calls to text. The text may be evaluated by a software routine to plot the customer interaction into service behaviors. The software routine addresses service issue such as whether the customer service representative asked the customer qualifying questions, whether the customer service representative thanked the customer. That objective behavioral data, and other available behavioral data, may be used as an additional layer or booster layer to help the machine learning model to specifically target an employee. For example, if a service metric indicates that an employee was below a goal in attainment of a particular metric and, in addition, the employee failed to qualify the customer or failed to thank the customer, those behaviors can be determined to be connected to particular metrics. The machine learning model can then find training courses related not only to the metric performance but also the behaviors that relate to that metric.

In another example, incorporating performance metrics can also include subjective information provided based on a human observation of an employee's performance. For example, an employee's supervisor or coach may observe the employee perform work tasks and have comments or feedback or coaching for the employee, based on the observation. The supervisor may use a suitable user interface to provide subjective data about the subjective observation of the employee's performance. Such subjective data may be created or obtained in any suitable manner, such as by operation of a user interface, personal computer, portable device such as a mobile, phone, and others. The subjective behavioral data may also be used as the additional layer or booster to help the machine learning model to identify training for the employee.

In some applications, there may be insufficient data to build a contextual multi-armed bandit (MAB) model. This may be the case, for example, at the initiation of operation of the model, before sufficient data has been collected. Also, a MAB model should be built for each different context. For example, if there are three variables, each with two possible values, this creates eight different contexts so eight MAB models must be built. However, there may not be enough data initially to build different models for each context. In this situation, to build models for each of the different contexts, a solution is to group information that is available. In the case of an employee training recommendation system, this includes grouping employee information and the performance information for the employees. However, in some cases, there is simply enough data to build all required models.

One effect solution is to use a booster layer with the MAB model. In this embodiment, initially a machine learning model is built without consideration of the context. In an example, one context is treated as an input to a non-contextual MAB model. For example, behavioral data may be retrieved from any source including from a commercial source such as StataPile, available at statapile.com. StataPile is an artificial intelligence platform that automates quality assurance. In accordance with an embodiment, a system and method can use input data such as StataPile behavioral data to group employees into subcategories and build regression models for each subcategory. Then, another layer can be added in addition to the output of the non-contextual MAB model. This operates to give the output scores from the non-contextual MAB model another weight.

In FIG. 2J, the flow diagram 270 shows data of a single context 271 being used to build n regression models, 272, 273, 274. The one context 271 is used as the input. The context 271 can include any appropriate data such as StataPile behavioral data. This behavioral data may come, for example, from different call center employees responding to user calls. The call center call data can be used to generate a score and be used to generate the context 271. For example, calls at the call center can be scored based on quality as “good,” “fair,” or “not good.” This creates three situations, and call center data can be collected that correlate to each respective situation. Then, a data set can be created which serves each different context. Records from the call center may be gathered for each situation. Using the records, regression models or linear regression models may be built corresponding to each situation. Thus, in FIG. 2J, a first regression model 272 is built for the “good” situation; a second regression model 273 is built for the “fair” situation; and the third regression model 274 is built for the “not good” situation from records of the call center. Linear regression models may be preferred in some applications given the good explainability and simplicity of the models.

Subsequently, additional call center records are collected as the calls occur. When a call generates a score or outcome of “good,” the record for that call will serve as an input to the regression model 272 and will generate a prediction as an output of the regression model 272. Similarly, when a future call generates a score of “not good,” the record for that call will serve as an input to the regression model 274 and will generate a prediction as an output or score of the regression model 274.

Scores produced as outputs from the regression models 272, 273, 274 may be normalized. For example, the scores may be multiplied to extend over a range from 0 to 1.5. It is desirable to have the results predicted by the regression models 272, 273, 274 in a range such as 0.0 to 1.x to make the multiplied results reasonable, which may require some normalization. Meanwhile, considering the confidence and support of the results, the number of examples may be used to normalize the predicted results.

The predicted, normalized results from the regression models 272, 273, 274 may then be provided to the contextual MAB model 275. The scores for the training course recommended by the contextual MAB model 275 may be multiplied by the predicted, normalized results from the regression models 272, 273, 274 to provide the final score for a recommended course for this learner for this KPI. The courses can then be recommended to the learner in accordance with other methods described herein.

Thus, other models can be generate other scores and combine the scores with the existing MAB model scores to customize a recommendation. In other applications, data other than behavioral data which may be used to reflect an assumption of most regression models that each observation is independent of other observations. Some behavioral contexts or data might be correlated and might produce unsatisfactory results.

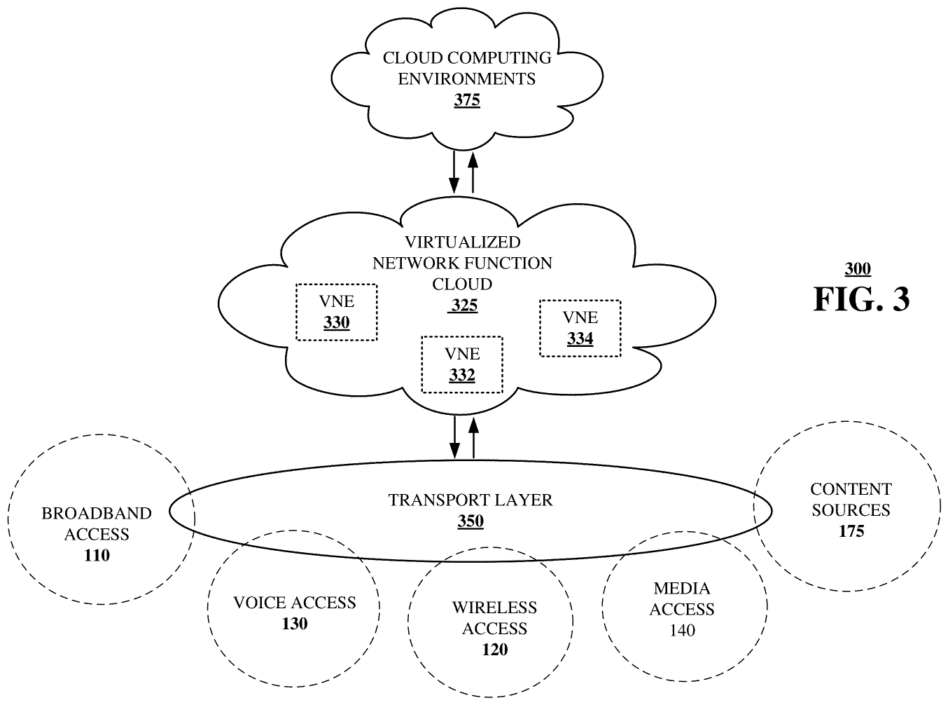

Referring now to FIG. 3, a block diagram of a virtualized communication network 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and workflow 230 presented in FIGS. 1, 2A through 2J and 3. For example, virtualized communication network 300 can facilitate in whole or in part implementing a real time training system for learners including employees of an organization in which training courses are recommended based on performance data for the learners using a machine learning model.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

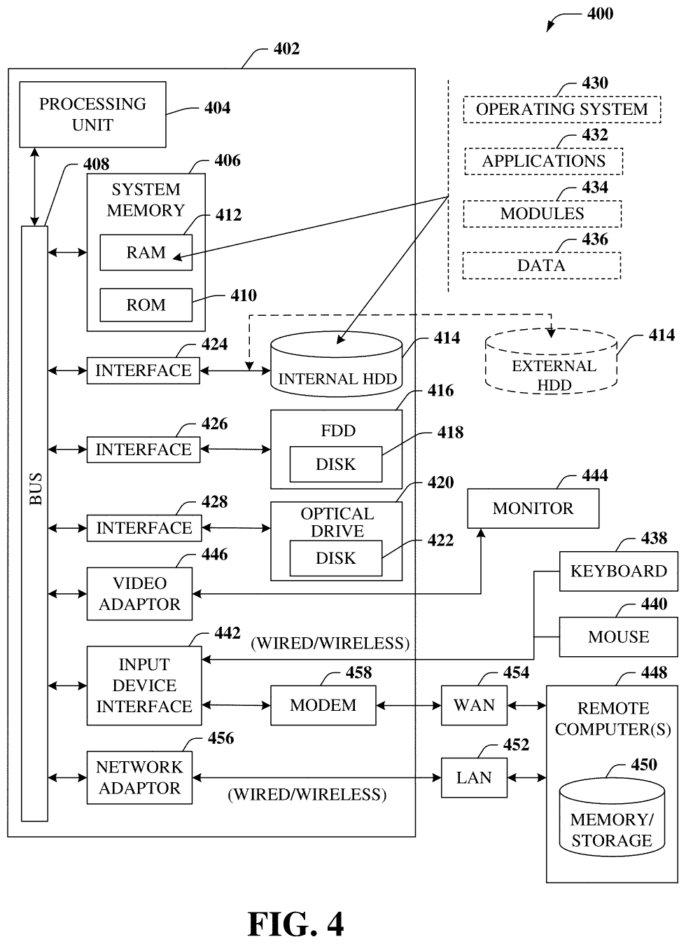

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part implementing a real time training system for learners including employees of an organization in which training courses are recommended based on performance data for the learners using a machine learning model. The computing environment may, for example be implemented as a server for generating recommended training for learners or as a handheld device used by an employee for performing work tasks and for viewing and interacting with recommended training courses.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418 ) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

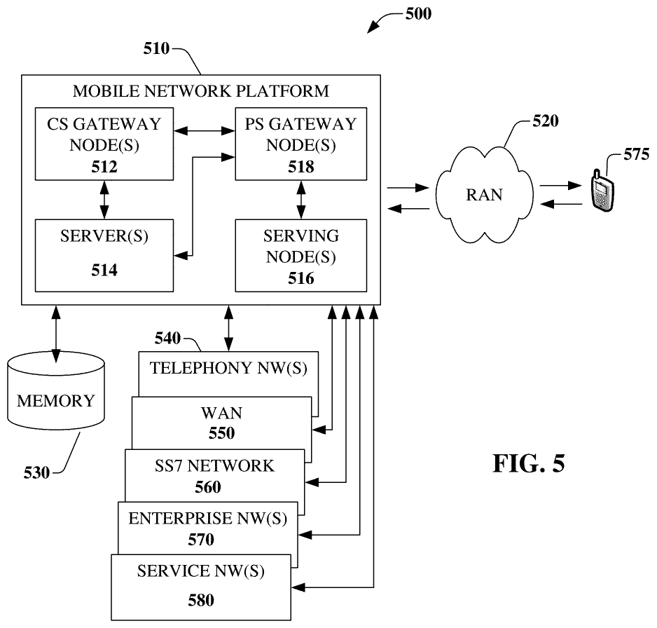

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part implementing a real time training system for learners including employees of an organization in which training courses are recommended based on performance data for the learners using a machine learning model. The mobile network platform 510 may, for example be operate to communicate recommended training courses to learners who may access the training courses by means of a handheld device used by an employee for performing work tasks and for viewing and interacting with recommended training courses. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

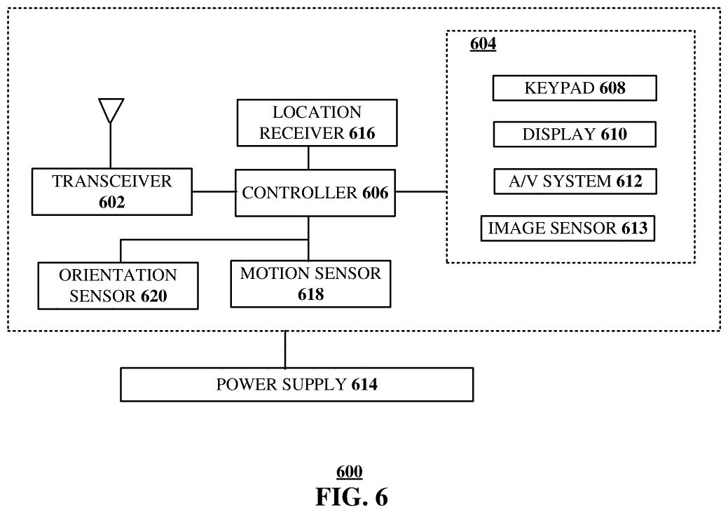

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part implementing a real time training system for learners including employees of an organization in which training courses are recommended based on performance data for the learners using a machine learning model. The communication device may, for example be in in communication with a server which generates recommended training for learners. In another example, the communication device 600 may be implemented as a handheld device used by an employee for performing work tasks and for viewing and interacting with recommended training courses.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving learning content information about one or more training courses, wherein each course of the one or more training courses is targeted to a specific key performance indicator of an organization;
receiving metric information about employee key performance indicators (KPIs) for performance of an employee;
generating, by a machine learning model, a training recommendation for the employee, wherein the generating comprises matching the metric information about employee KPIs to the learning content information of the one or more training courses;
producing a list of recommended courses for the employee based on the training recommendation;
collecting information about completion of a training course of the recommended courses for the employee;
collecting performance information about the employee KPIs for the performance of the employee following the completion of the training course;
comparing the performance information about the employee KPIs with the metric information about employee KPIs to produce a performance comparison; and
modifying content of the training course based on the performance comparison.

2. The device of claim 1, wherein the modifying content of the training course comprises:
automatically modifying a format of the training course to produce a modified course; and
storing data defining the modified course with the one or more training courses in a course catalog.

3. The device of claim 2, wherein the automatically modifying a format of the training course comprises reordering web pages of a plurality of web pages forming the training course to produce the modified course.

4. The device of claim 1, wherein the operations further comprise:
receiving employee information about employees including the employee;
based on the performance comparison and the employee information, identifying a most effective training format for a group of employees including the employee; and
modifying the content of the training course according to the most effective training format.

5. The device of claim 4, wherein the operations further comprise:
exploring, by the machine learning model, a plurality of training formats and relative effectiveness of each training format for the employee and an employee KPI for the employee.

6. The device of claim 1, wherein the operations further comprise:
receiving, from an employee device of the employee, a request to access the training course of the recommended courses;
providing the content of the training course to the employee device; and
providing supplemental content to the employee device, wherein the supplemental content collects data about interaction with the content by the employee on the employee device.

7. The device of claim 6, wherein the collecting performance information about the employee KPIs for the performance of the employee following the completion of the training course comprises collecting the performance information from the employee device.

8. The device of claim 1, wherein the operations further comprise:
generating, by the machine learning model, a manager training recommendation for a manager of the employee, wherein the generating a manager training recommendation comprises matching the metric information about employee KPIs to the recommended training information of manager training courses for the manager.

9. The device of claim 1, wherein the operations further comprise:
collecting behavioral data of the employee, wherein the behavioral data is based on performance behaviors of the employee; and
providing the behavioral data to the machine learning model; and
generating, by the machine learning model, the training recommendation for the employee based on the behavioral data.

10. The device of claim 1, wherein the generating, by the machine learning model, the training recommendation for the employee comprises generating the training recommendation using a contextual multi-armed bandit machine learning model.

11. A machine-readable medium, comprising executable instructions that, when executed by a processing system including a processor, facilitate performance of operations, the operations comprising:
receiving employee performance data for a group of employees including a particular employee, the employee performance data including particular performance data for the particular employee, the employee performance data associated with a selected time period, the employee performance data associated with key performance indicator (KPIs) for the group of employees including a particular KPI associated with the a task performed by the particular employee;
determining, for a plurality of training courses, a probability of each training course being associated with improved performance by the group of employees for each KPI of the KPIs, producing a probability distribution and a confidence score;
recommending, based on the probability distribution, one or more recommended training courses for the employee;
exploring, based on the confidence score, training courses of the plurality of training courses having a relatively low confidence score;
receiving subsequent performance data for the group of employees, the subsequent performance data associated with a time period following completion of the one or more recommended training courses by the particular employee;
evaluating effectiveness of the one or more training courses based on the subsequent performance data; and
modifying at least one recommended training course of the one or more recommended training courses, wherein the modifying is responsive to the evaluating effectiveness.

12. The machine-readable medium of claim 11, wherein the modifying at least one recommended training course of the one or more recommended training courses comprises changing a presentation format of the at least one recommended training course.

13. The machine-readable medium of claim 11, wherein the operations further comprise:
providing information about effectiveness of the one or more recommended training courses to a content creator of the one or more recommended training courses;
receiving information from the content creator, the information defining an updated training course, wherein the updated training course includes content modified by the content creator based on the information about effectiveness; and
subsequently, recommending the updated training course for employees of the group of employees.

14. The machine-readable medium of claim 11, wherein the operations further comprise:
receiving behavioral data for employees of the group of employees; and
recommending, based on the behavioral data and the probability distribution, one or more training courses for the employee.

15. The machine-readable medium of claim 14, wherein the receiving behavioral data for employees comprises:
receiving objective behavioral data based on automated measurements of performance of the employees; and
receiving subjective behavioral data based on human observation of the performance of the employees.

16. The machine-readable medium of claim 11, wherein the operations further comprise:
exploiting, based on the confidence score, training courses of the plurality of training courses having a relatively high confidence score, wherein the exploring and exploiting are performed using a contextual multi-armed bandit machine learning model.

17. A method, comprising:
receiving, by a processing system including a processor, key performance indicator (KPI) performance data for an employee, wherein the KPI performance data is related to a particular job function of the employee in a role of the employee for a just completed time period;
recommending, by the processing system, a training course for the employee, wherein the recommending is based on the KPI performance data, a tenure of the employee in the role and a confidence level for the training course, the training course to be completed by the employee in an immediately following time period;
determining, by the processing system, that the employee has completed the training course;
receiving, by the processing system, subsequent KPI performance data for the employee after the employee has completed the training; and
updating, by the processing system, the confidence level for the training course based on the subsequent KPI performance data.

18. The method of claim 17, wherein the just completed time period comprises a previous month and the immediately following time period comprises a following month and wherein the training course can be completed by the employee in a time duration less than 15 minutes.

19. The method of claim 17, wherein the receiving KPI performance data comprises automatically receiving, by the processing system, the KPI performance data from a handheld device used by the employee in the particular job function, and wherein the employee completes the training course using the handheld device.

20. The method of claim 17, comprising:
recommending, by the processing system, the training course for the employee based on a contextual multi-armed bandit machine learning model.
